(19) United States
(12) Patent Application Publication
(10) Pub. No.: US 2015/0186804 A1
(43) Pub. Date: Jul. 2, 2015

(54) METHOD AND SYSTEM FOR GENERATING REAL PROPERTY LISTINGS

(71) Applicant: Steffen Meschkat, Zurich (CH)

(72) Inventor: Steffen Meschkat, Zurich (CH)

(73) Assignee: GOOGLE INC., Mountain View, CA (US)

(21) Appl. No.: 13/096,223

(22) Filed: Apr. 28, 2011

(51) Int. Cl. G06Q 50/00; G06F 17/30; G06Q 50/16

(52) U.S. Cl. CPC G06Q 10/06; G06Q 50/16; G06F 17/30241; G06F 17/30864

(57) ABSTRACT

A computerized system includes a real property database having a plurality of unclaimed entries, each unclaimed entry representing a geographic location and comprising at least a geographic location field containing information regarding the geographic location and one or more additional editable fields, and a communication and editing system in communication with the database and a remote computer. The communication and editing system is programmed to display information relating to an unclaimed entry, receive from the remote computer a selection of the unclaimed entry, confirm that the selection originated with the right holder associated with the geographic location, provide the right holder with the ability to edit the one or more additional editable fields associated with the entry, and subsequently modify a transfer price field in response to an edit command received from the right holder, the transfer price field containing information regarding a transfer price associated with the geographic location.

### FIELD OF TECHNOLOGY

This patent is directed to system and method for generating real property listings, and in particular a system and method for generating real property listings at least in part prior to owner adoption of the listing.

### BACKGROUND

When real property is offered for sale, the owner or an agent of the owner (which may be a real estate broker) will prepare a description of the real property that is circulated to other parties with the intent of attracting the attention of a prospective buyer or an agent of the buyer.

In many locations, real estate brokers have formed trade organizations that allow the member brokers to enter the description generated regarding a particular real property into a centralized database. The database will generally adhere to a predetermined set of criteria and rules in regard to the description. The database associated with a Multiple Listing Service (MLS) is one example of such a centralized database used by real estate brokers in the U.S.

One limitation of such MLS databases is that they are generally closed to outsiders. In particular, a particular MLS database is only generally available to real estate brokers who qualify for access to that particular MLS database and are members of the relevant trade association(s). While a specific MLS may permit non-brokers to view parts of the MLS database, non-brokers or non-members generally do not have unrestricted access to the database. Moreover, non-broker owners are generally unable to post a listing to the database.

Another limitation is that the owner or the broker working with the owner (typically referred to as the seller's agent) typically must generate the description of the real property at the time the owner decides to sell the real property, as mentioned above. Consequently, while the owner or agent may work from examples of similar descriptions prepared for other properties, the process of preparing the description is performed at the time the owner decides to offer the real property for sale.

### SUMMARY

According to an aspect of the present disclosure, a computer implemented method for use with a computerized database is provided. The database includes a plurality of unclaimed entries, each unclaimed entry comprising at least a geographic location field containing information regarding a geographic location and one or more additional editable fields. The method includes displaying information relating to an unclaimed entry at a remote computer, receiving from the remote computer a selection of the unclaimed entry, confirming that the selection originated with a right holder associated with the geographic location, and providing the right holder with the ability to edit the one or more additional editable fields associated with the entry. The method also includes subsequently modifying a transfer price field in response to an edit command received from the right holder, the transfer price field containing information regarding a transfer price associated with the geographic location.

According to another aspect of the present disclosure, a computerized system includes a real property database including a plurality of unclaimed entries, each unclaimed entry representing a geographic location and comprising at least a geographic location field containing information regarding a geographic location and one or more additional editable fields. The system also includes a communication and editing system in communication with the database and a remote computer. The communication and editing system is programmed to display information relating to an unclaimed entry, receive from the remote computer a selection of the unclaimed entry, confirm that the selection originated with the right holder associated with the geographic location, and provide the right holder with the ability to edit the one or more additional editable fields associated with the entry. The communication and editing system is also programmed to subsequently modify a transfer price field in response to an edit command received from the right holder, the transfer price field containing information regarding a transfer price associated with the geographic location.

According to a further aspect of the present disclosure, a computerized system includes a real property database comprising a plurality of unclaimed entries, each unclaimed entry representing a geographic location and comprising at least a geographic location field containing information regarding a geographic location and one or more additional editable fields. The system also includes a communication and editing system in communication with the database and a remote computer. The communication and editing system programmed to receive from the remote computer a selection of the unclaimed entry, confirm that the selection originated with the right holder associated with the geographic location, modify a transfer price field in response to an edit command received from a right holder, the transfer price field containing information regarding a transfer price associated with the geographic location, and subsequently display a real property listing image including indicia representative of the geographic location and the transfer price.

According to a still further aspect of the present disclosure, a computer implemented method is provided for use with a computerized database comprising a plurality of unclaimed entries, each unclaimed entry comprising at least a geographic location field containing information regarding a geographic location and one or more additional editable fields. The method includes collecting information regarding an unclaimed entry, storing the information in one or more of the additional editable fields, subsequently receiving from the remote computer a selection of the unclaimed entry, confirming that the selection originated with a right holder associated with the geographic location, subsequently modifying a transfer price field in response to an edit command received from the right holder, the transfer price field containing information regarding a transfer price associated with the geographic location, and displaying a real property listing image including indicia representative of the geographic location and the transfer price.

### BRIEF DESCRIPTION OF THE DRAWINGS

It is believed that the disclosure will be more fully understood from the following description taken in conjunction with the accompanying drawings. Some of the figures may have been simplified by the omission of selected elements for the purpose of more clearly showing other elements. Such omissions of elements in some figures are not necessarily indicative of the presence or absence of particular elements in any of the exemplary embodiments, except as may be explicitly delineated in the corresponding written description. None of the drawings is necessarily to scale.

FIG. 1 is a schematic of an exemplary computerized system that may be used with a computer implemented method for generating real property listings according to the present disclosure;

FIG. 2 is a flowchart of an exemplary computer implemented method for generating real property listings according to the present disclosure;

FIG. 3 is a table representing an exemplary computerized database with which the method for generating real property listings may be used;

FIG. 4 is a simulated screenshot of an image generated to convey information to a party relating to an unclaimed entry in the computerized database according to FIG. 3;

FIG. 5 is a simulated screenshot of an image generated from information edited by a right holder after selecting the unclaimed entry in the computerized database;

FIG. 6 is a simulated screenshot of a real property listing image associated with an entry for a real property in the computerized database according to FIG. 3;

FIG. 7 is a table representing further exemplary fields of the computerized database according to FIG. 3; and

FIG. 8 is a table representing still further exemplary fields of the computerized database according to FIG. 3.

### DETAILED DESCRIPTION

In general terms, the present disclosure relates to a computer implemented method for generating real property listings, as well as the associated system for carrying out the method. This method is for use with a computerized database (which may be referred to as a real property database) that includes a plurality of unclaimed entries, each unclaimed entry comprising at least a geographic location field containing information regarding a geographic location, such as may be related or associated with real property, and one or more additional editable fields. The database may be in communication with a communication and editing system that is programmed to carry out the method. For example, the method may include displaying information relating to an unclaimed entry at a remote computer, and receiving from the remote computer a selection of the unclaimed entry. Once it has been confirmed that the selection originated with a right holder associated with the geographic location, the right holder is provided with the ability to edit the one or more additional editable fields associated with the entry. Subsequently, the right holder may modify a transfer price field, for example, by sending an edit command to the communication and editing system, the transfer price field containing information regarding a transfer price associated with the geographic location. From this information, a real property listing image may be generated and displayed including indicia representative of the geographic location and the transfer price.

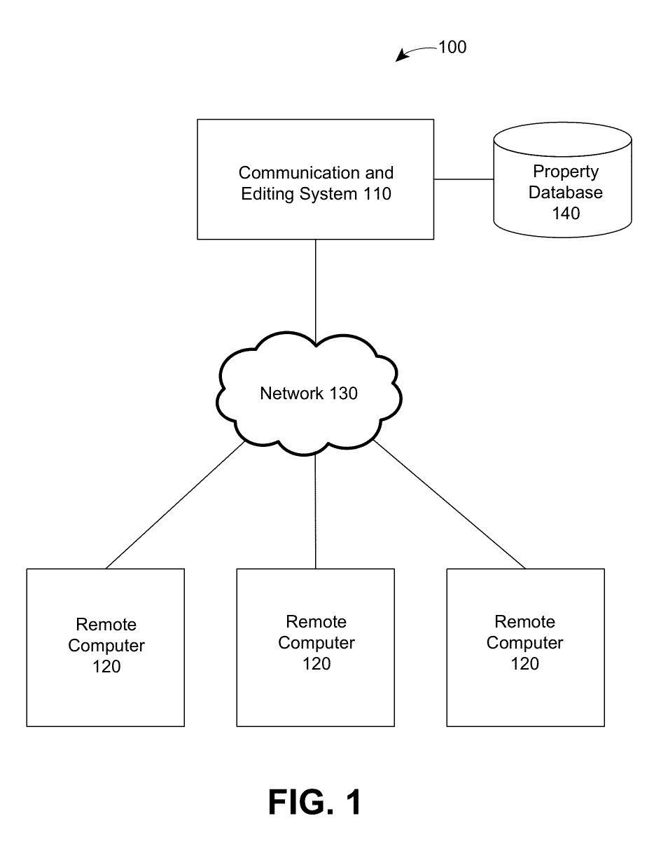

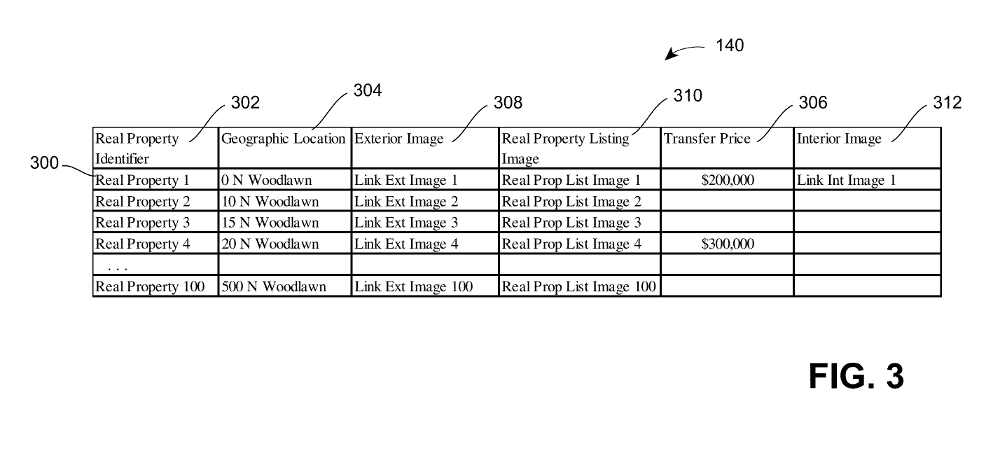

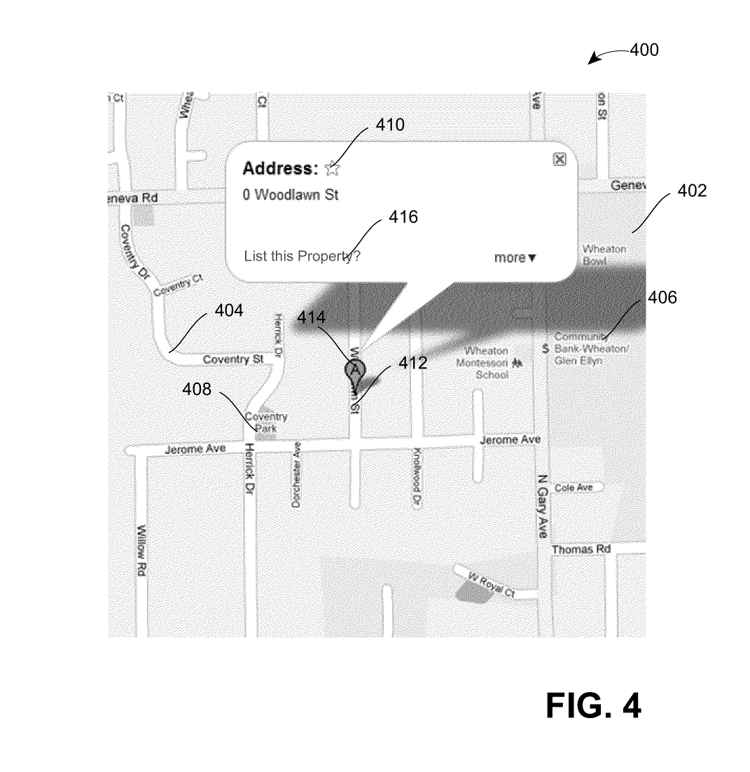

As to one embodiment of the present disclosure, FIG. 1 illustrates a computing environment 100 for a computer implemented method for generating listings for real property (“real property listings”). As seen in FIG. 1, the computing environment 100 includes a communication and editing system 110, in the form of one or more servers, connected to a number of remote computers 120 through one or more networks 130. A computerized real property database 140 is illustrated as associated with and in communication with the communication and editing system 110. The database 140 is further illustrated in subsequent FIGS. 3, 7, and 8, while FIGS. 4, 5, and 6 illustrate various simulated screen shots of displays that may be generated in conjunction with the method 200.

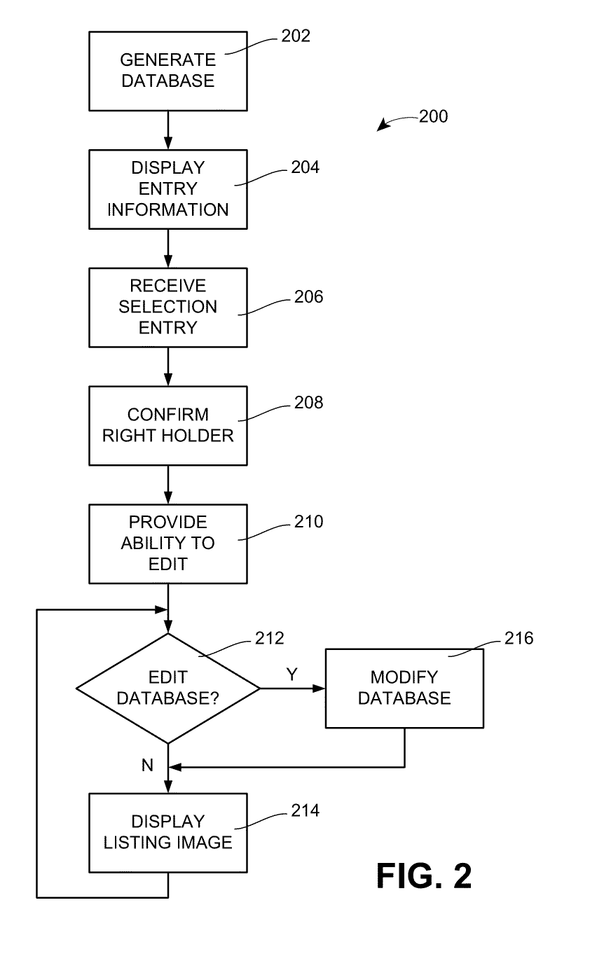

In a similar fashion, FIG. 2 illustrates a computer implemented method 200 for generating real property listings for use with the computing environment or system 100. The method 200 is for use with a real property database that has already been generated, at least in part, prior to obtaining the ability to edit an unclaimed entry of the database being made to a party holding an ownership right in the real property represented by this entry in the database. That is, the method 200 is for use with a computerized real property database 140 to generate real property listings in which at least part of the information for a particular real property listing is included or stored in the database 140 prior to the party holding rights in a specific real property (referred to herein as the “presumed right holder” or “right holder”) “claiming” the entry by selecting the entry 300. Obviously, the unclaimed entry may thus be generated well before the right holder decides to offer to transfer all or part of the rights associated with the real property to a transferee (which may be a buyer, a lessee, or an agent of one of these transferee, according to the facts of the contemplated transaction). In this regard, the method 200 does not necessarily wait for a right holder to make the decision to sell real property or to lease a building or a unit of a building associated with real property before establishing an entry for the real property in the real property database 140. Instead, the method 200 (and the system 100 carrying out the method 200) provides the right holder with a pre-established unclaimed entry representative of the real property that may then be claimed and edited by the right holder to provide a tailored real property listing for the real property and the rights the right holder intends to transfer.

Consequently, according to certain embodiments of the present disclosure, the party who will provide the right holder the ability to edit an entry in the database 140 (also referred to herein as the service provider) first generates the database 140 at a block 202. According to other embodiments of the present disclosure, the database 140 may be generated by a party other than the service provider, which party may be referred to herein as a database generator. The database generator may be under the control of the service provider, or alternatively the database generator may generate the database 140 without instruction from the service provider and subsequently transfer the database 140 to the service provider in conjunction with the service provider carrying out the method 200.

By way of example, an exemplary database 140 is illustrated in FIG. 3. While a tabular representation has been established for the database 140 and used in FIGS. 3, 7 and 8, no limitation is intended by this tabular representation, but it is used simply for ease of illustration. The database 140 may include a plurality of entries 300, each entry 300 representing an individual real property, as identified in a real property identifier field 302 of the database 140. In this regard as well, no limitation is intended by the use of the term “field,” for while such a term is generally used in regard to structured data, the present disclosure is also directed, for example, to embodiments where the specific attributes of an entry are represented as semi-structured data and may be designated using markup embedded in freeform text, such as using the Extensible Markup Language (XML) for example. Moreover, each entry 300 may represent an individual and unique real property according to certain embodiments. Furthermore, each entry 300 may include at least a geographic location field 304 containing information regarding a geographic location of the real property. One or more additional fields (e.g., a field 306) may also be included, as illustrated in FIG. 3.

Having thus established the database 140, the method 200 may continue on to a block 204, wherein information relating to an unclaimed entry 300 representing a real property (e.g., Real Property 1, Real Property 2, etc.) having an ownership right that is transferrable from a right holder to a transferee and one or more additional editable fields (e.g., field 306) is displayed on a remote computer 120. According to the present disclosure, the real property may be a unit of land and/or an associated building. According to such an embodiment, the proposed transfer may include all legal rights to the real property (e.g., a fee simple). Alternatively, the real property may be a unit of a multidwelling building, such as a duplex or an apartment building. According to such a further embodiment, the proposed transfer may include all legal rights to the real property or may be a lease to the real property. Other embodiments are also possible, such as one in which there is no building on the unit of land, and the proposed transfer may be of the unit of land itself.

FIG. 4 illustrates an embodiment of an image 400 displayed to convey information regarding the unclaimed entry. The image 400 may include a map image 402 of a geographic region that includes a particular geographic location associated with a real property represented by an entry 300 in the database 140. The map image 402 may include illustrations of streets 404, commercial properties 406 and governmental properties, such as a park 408, although it may include illustrations of other items as well. The map image 402 may also include a link 410 to a real property listing image (to be discussed in greater detail hereinafter) at a location 412 on the map image 402 associated with the geographic location of the real property in question. In fact, the map image 402 may include a listing icon 414 at the location 412 on the map image 402 associated with the geographic location of the real property in question to highlight the availability of the link 410 to the real property listing image.

The right holder may access the image 400 in a number of different fashions. For example, the image 400 may be returned as the result of a query entered by the right holder into a search engine, with reference to a keyword or an address. Alternatively, the right holder may receive the image 400 as the result of navigating an interactive map display and arriving at the particular geographic location, whereupon the image 400 may be accessed using a pointing device (e.g., a mouse, touchpad, touchscreen, etc.) to interact with the interactive map display. It will be recognized that a combination of these actions may be used by the right holder to access the image 400.

The map image 402 of FIG. 4 may also include a link 416 that is particularly associated with the information as to an entry 300 representing a real property associated with location 412 on the map image 402. Selection of the link 416 causes a message to be sent from the computer 120 to the communication and editing system 110. The message sent from the computer 120 to the communication and editing system 110 when this link 416 is selected may be referred to as a selection. At some point after the message is sent, the communication and editing system 110 will receive the selection at block 206 of the method 200, and the method 200 will proceed to block 208.

The communication and editing system 110 will then take additional actions to confirm that the selection originated with the right holder associated with the geographic location who can transfer an ownership right to the real property associated with the entry 300 to a transferee. The act of confirmation, represented by the block 208 in FIG. 2, may be performed in a variety of fashions, and is not intended to guarantee that the right holder is in fact the right holder of the real property in question according to all embodiments. It is understood that whether the right holder is indeed the holder of the rights to the real property that the right holder, or more properly the presumed right holder, represents that he or she holds may be established during the legal process used to transfer the rights from the presumed right holder to the transferee. As such, according to certain embodiments of the present disclosure, the measures taken to establish that the right holder should be given the right to edit the entry for a particular property may not establish to a legal certainty that the right holder is indeed who he or she represents that they are and that the right holder does indeed hold the rights to the particular real property in question. However, according other embodiments, methods may be used that establish both of these facts to a legal certainty, and thus may relied upon by those viewing the property listings. Obviously, the methods used to establish these facts will vary from jurisdiction to jurisdiction, but the implementation of these methods would fall within the scope of one of skill in the art. In any event, the party with rights to edit the entry for a property listing will be referred to as the presumed right holder herein, or right holder for short, without the limitation that steps have been taken that the right holder is the right holder as determined to a legal certainty.

For example, the party sending the selection to the communication and editing system 110 may be requested to provide a telephone number at which the party may receive a token via Short Message Service (SMS) or an e-mail address at which the party may receive a message. Upon receipt of the telephone number or e-mail address by the communication and editing system 110, the token will be sent to the telephone number or e-mail address of the party sending the selection if the telephone number or e-mail address is associated with the right holder. The right holder may then transmit the token to the communication and editing system 110 to complete the act of confirmation. Alternative methods may also be used, such as wherein the right holder must establish an account (potentially password-protected), and requiring the right holder to associate a phone number or a residential address or other information with the account to which an access code (which would function as the token) is transmitted/sent or to associate a credit card number with the account.

Once the act of confirmation is completed, the communication and editing system 110 will provide the right holder with the ability to edit the one or more additional editable fields associated with the real property (the entry 300) as represented by block 210 in FIG. 2. It will be recognized that by receiving the ability to edit the one or more additional fields, the right holder may not receive the ability to edit every field associated with the real property. According to certain embodiments, certain fields may be editable by only members of a particular class of users (e.g., database administrators) that do not include the right holder. For example, the real property identifier field 302 may not be editable by the right holder. Moreover, the ability to edit may not be coextensive with the right to delete material from the field according to certain embodiments. For example, the ability to edit may permit the right holder to add information to the field, but not delete the information already present. This arrangement may be desirable relative to a field for which it is important to preserve the history of changes made to the field to provide the ability to store and even display the evolution of the changes to a field over time.

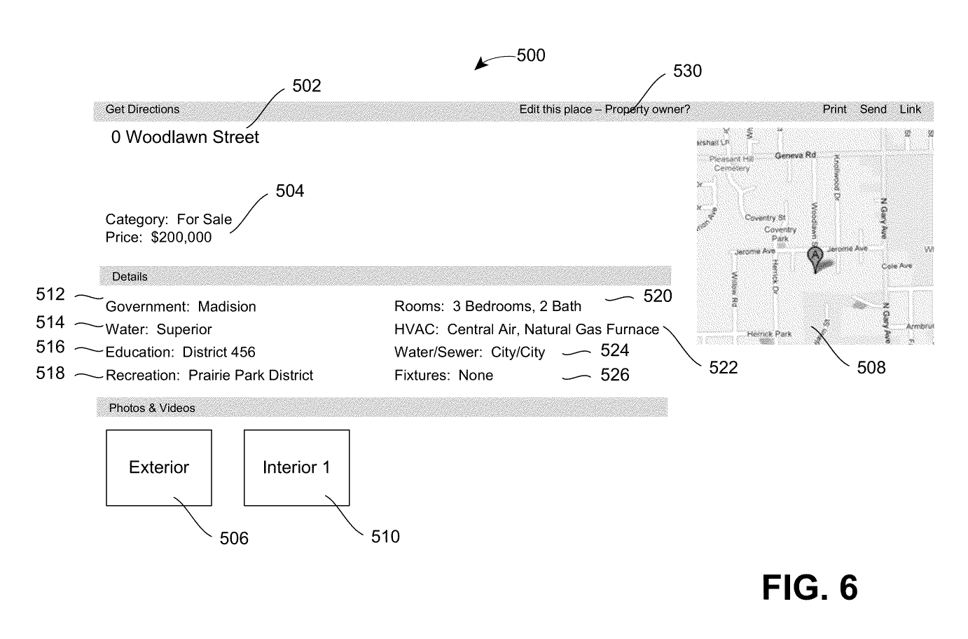

Subsequent to receiving the ability to edit the one or more additional fields, the communication and editing system 110 may then determine at block 212 whether the right holder wishes to edit the entry 300. If the right holder does not wish to edit the entry 300, the method 200 proceeds to the display of the real property listing image referred to previously. This is represented at block 214 in FIG. 2, and will be discussed in greater detail below with reference to FIG. 6.

However, the right holder may wish to modify the fields associated with the entry 300 representing the real property for which he or she is the right holder. Therefore, after the ability to edit has been provided to the right holder at block 210, the system 110 may determine at block 212 that the right holder wishes to modify one or more of the additional fields associated with the entry 300, for example through the receipt of an edit command. The system 110 may then modify the entry 300, and in particular one or more of the associated fields, as represented by block 216 in FIG. 2.

As one example, the right holder may send an edit command to the communication and editing system 110 to subsequently modify, for example, a transfer price field 306. The transfer price field 306 may contain information regarding a transfer price associated with the geographic location, such as may desired by the right holder for transfer of the ownership right of the real property from the right holder to the transferee. The communication and editing system 110 may then modify the transfer price field 306 for the entry 300 in question in response to the edit command received from the right holder to include this information. As noted above, the transfer price field 306 may be one of those fields for which information may be added, but not deleted, so that the history and evolution of the price may be stored, and potentially even displayed.

In particular, with reference to entry 300 associated with Real Property 1 in FIG. 3, the transfer price field 306 may initially be blank. However, the right holder, after obtaining the ability to edit the entry 300, may decide to include a transfer price that the right holder would be willing to accept for a transfer of some or all ownership rights to the real property from himself or herself to a transferee (i.e., a buyer or the buyer's agent). As illustrated in FIG. 3, the right holder associated with Real Property 1 is willing to accept $200,000 in exchange for a transfer of the ownership right of the real property to the prospective buyer or the buyer's agent.

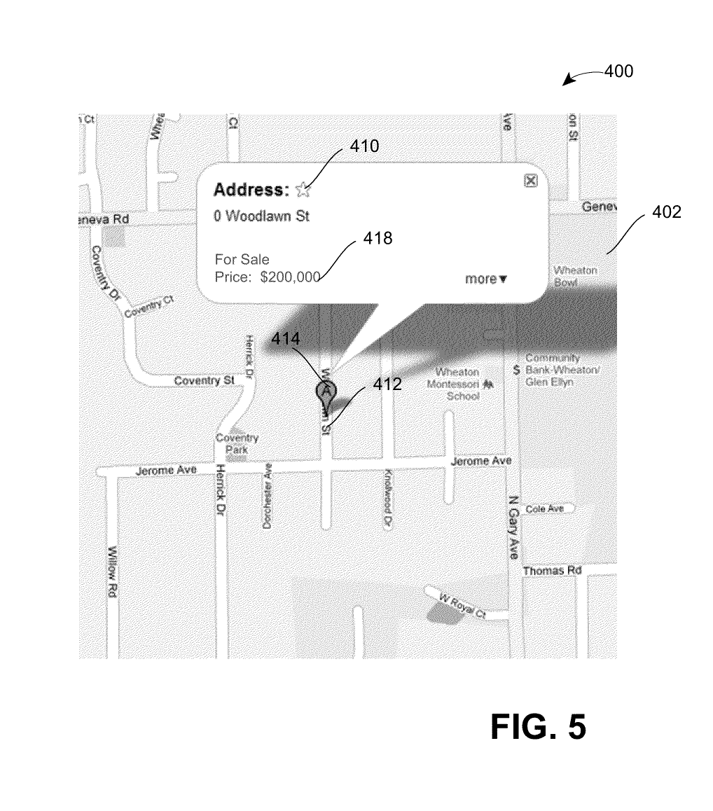

Once this modification of the entry 300 has taken place, the image 400 may also be modified, as illustrated in FIG. 5. In particular, while the image 400 includes the map image 402 and the link 410 at the location 412, along with the icon 414, the image 400 also includes a new link 418 with information obtained from the transfer price field 306. Specifically, the link 418 includes reference to the fact that the real property is “for sale” and that the right holder associated with the real property is willing to accept $200,000 for the transfer of all ownership rights in the real property from himself or herself to the transferee.

Of course, it will be recognized that the method 200 as explained thus far is a simplified, but complete, disclosure of the information that may be associated in the database 140 with an entry 300 for a particular real property (e.g., Real Property 1) for which rights are to be transferred from one party to another: i.e., geographic location and transfer price. It will be further recognized that it is customary for additional information to be provided concerning a real property for which a transfer of ownership right is to occur. According to certain embodiments, this additional information may be included in fields associated with the entry 300 prior to the time the right holder can edit the real property listing. Alternatively, according to other embodiments, additional fields associated with the entry 300 may be modified at the request of the right holder (e.g., through the receipt of one or more edit commands via the communication and editing system 110). In either event, the information associated with the additional fields may cause further modifications to the image 400, or may even be displayed in the real property listing image associated with the link 410 displayed on the image 400 mentioned above and discussed in detail below.

As to information established prior to selection, the party that generated the database 140 may associate one or more exterior images of a building associated with the real property represented by the entry 300 in an exterior image field 308, in addition to generating the information included in the real property identifier and geographic location fields 302, 304. The exterior image(s) may be generated by the party that generated the database 140, or may be generated by a third party at the request and instruction of the party that generated the database 140. As a still further alternative, the exterior image(s) may be generated by a third party, and then the party that generated the database 140 may subsequently associate the exterior image with the entry 300 prior to the selection of the entry 300 by the right holder at block 206 of the method 200.

As illustrated in FIG. 3, one or more exterior images may be associated with the entry 300 in the exterior image field 308 through the association of a link to the exterior image in the field 308. Other alternative methods for associating the exterior image with a particular entry 300 and the exterior image field 308 may be adopted. As a consequence, the illustrated embodiment is simply an exemplary embodiment according to the present disclosure.

It will also be noted with reference to FIG. 3 that a real property listing image field 310 is also provided for each entry 300. The real property listing image field 310 and the associated real property listing image also may be generated prior to the selection of the entry 300 by the right holder. See, for example, the real property image listing fields 310 for the entries 300 associated with Real Property 2, Real Property 3, and Real Property 100, none of which have been accepted by the associated right holder but which include reference to real property listing images. According to the present embodiment, a real property listing image is generated for each of these entries 300 and associated with each of these entries 300 in the respective real property listing image field 310 prior to selection.

FIG. 6 is an illustration of a simulated screen shot of a real property listing image 500. The real property listing image 500 includes information that may be found in one or more of the fields associated with the entry 300 for this particular real property (Real Property 1). For example, the real property listing image 500 may include indicia (e.g., numeric, alphanumeric, or alphabetic characters) representative of information concerning the geographic location of the real property at 502, and indicia representative of information concerning the transfer price at 504. The image 500 may also include images, such as the one or more exterior images 506 as well as a map image 508 that identifies the geographic location of the real property in question relative to streets, commercial properties and governmental properties. Moreover, the information displayed may include all, part or none of the information stored in a particular field of the entry 300 (e.g., only the most recent transfer price may be displayed according to an embodiment of the present disclosure where the right holder may edit the transfer price field 306 only by adding to the information previously entered). Additional information may be displayed on the image 500 as will be explained in greater detail with the further embodiments discussed herein.

In addition to the pre-established information (i.e., information associated with the fields of the entry 300 prior to selection by the right holder), the fields may also include information that was associated with the fields in response to edit commands received from the right holder. Like the pre-established information included in the fields, the information included in response to edit commands from the right holder may be further reflected in modifications of the real property listing image 500.

As seen in FIG. 3, the database 140 may include an interior image field 312, in which is included information associating one or more interior images of a building located on the real property in question with an entry 300 representing that real property. Unlike the exterior image(s), which may be provided by the party generating the database 140 or a party acting on their behalf, the interior images(s) of the building on the real property will most likely be provided by the right holder or a party acting on behalf of the right holder. Thus, the communication and editing system 110 will most likely modify the interior image field 312 in response to an edit command received from the right holder to associate the interior image(s) with the entry 300. It will also be recognized that while an exterior image field 308 and an interior image field 312 have been introduced with respect the illustrated embodiment, this should not be seen as precluding additional image fields, or an embodiment including a single image field that associates exterior, interior, and other images.

According to the present disclosure, the interior images associated with the entry 300 by the interior image field 312 may be included in the real property listing image 500. For example, as illustrated in FIG. 6, the real property listing image 500 may include the one or more interior images of the building associated with the real property at 510, in addition to including indicia representative of the geographic location of the real property and the transfer price at 502, 504, for example.

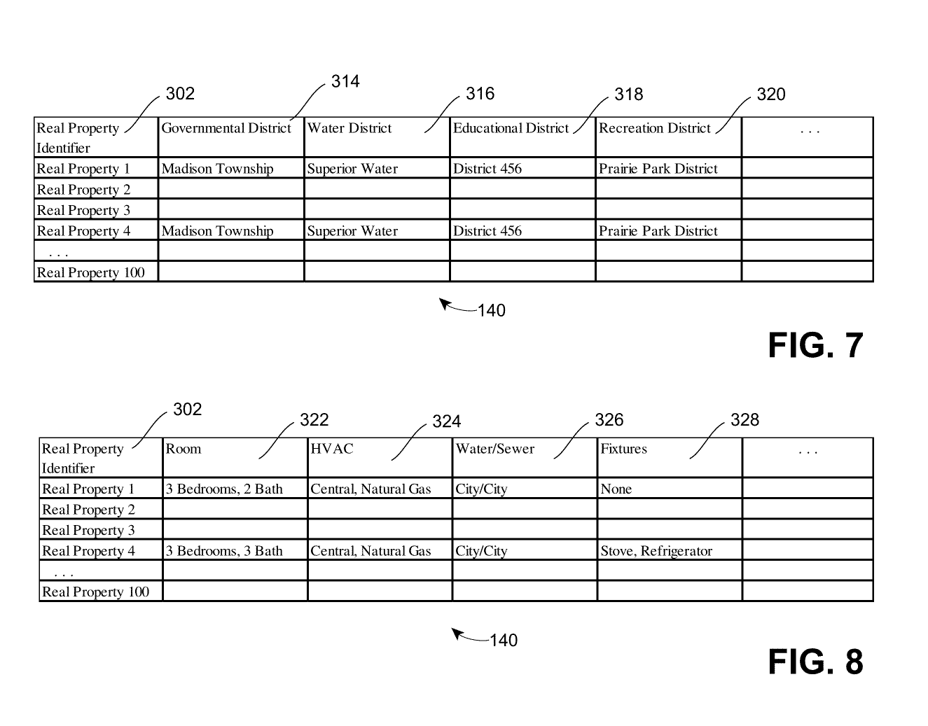

The database 140 may include further information in additional fields associated with each of the entries 300. Certain exemplary fields are illustrated in FIGS. 7 and 8. Fields containing information that may be obtained from public sources are included in FIG. 7 and are likely to include pre-established information according to certain embodiments, while fields containing information that will likely be available only from the right holder are included in FIG. 8, although these fields may include pre-established information according to certain embodiments as well. As noted above, information associated with these fields may be included in the real property listing image 500, as were the interior images at 510.

For example, FIG. 7 illustrates four additional fields 314, 316, 318, 320 associated with the real property. According to the present disclosure, the field 314 may contain information representative of a governmental district (e.g., city, township, etc.) in which the real property is located. The field 316 may include information on a water district that provides water service to the real property; in a situation where the real property has its own water supply (e.g., well), this field may include an identifier of this fact as well. The field 318 may include one or more educational districts associated with the real property, for example public primary and secondary educational districts. Further, field 320 may include information on a recreation district, such as a park district, associated with the real property. According to such an embodiment, the communication and editing system 110 may modify the one or more additional fields 314, 316, 318, 320 in response to an edit command received from the right holder to include information representative of one or more of a government district, a water district, an educational district, and a recreation district.

The information thus stored in the database may subsequently be displayed in the real property listing image 500. For example, the real property listing image 500 may including indicia representative the government district at 512, the water district at 514, the educational district at 516, and the recreation district at 518, in addition to indicia representative of the geographic location of the real property and the transfer price at 502, 504. As a consequence, a party viewing the image 500 may obtain additional information regarding the real property from the real property listing image 500 at a glance.

FIG. 8 also illustrates four additional fields 322, 324, 326, 328 associated with the real property, although as mentioned previously these fields generally relate to information that may not be of public record relative to the real property. According to the present disclosure, the field 322 may contain information representative of the number of rooms and/or the type of rooms associated with the real property. For example, the field 322 may include reference to the number of bedrooms, bathrooms, and other living spaces. The field 324 may include information regarding the heating, ventilation, and air conditioning (HVAC) equipment associated with the real property. For example, the field 324 may include reference to whether the heating is generated by a gas-fired furnace or an electrical heater, or if central air conditioning is included. The field 326 may include information regarding the water and sewer connections, and may thus overlap to a certain degree with the water district field 316 in that properties obtaining their water from a pump may be designated differently from those obtaining water through a city water connection. Finally, the field 328 may include information on fixtures provided with the real property, such as refrigerators, dishwashers, stoves and other items that would be transferred with the real property, or more particularly a building located on the real property. According to one embodiment, the communication and editing system 110 may modify one or more of the fields 320, 322, 324, 326 in response to an edit command received from the right holder to include information representative of a room description, a HVAC description, a water/sewer description, and a fixture description, for example.

The information thus stored in the database 140 may subsequently be displayed in the real property listing image 500. For example, the real property listing image 500 may include indicia representative of the room description at 520, the HVAC description at 522, the water/sewer description at 524, and the fixture description at 526, in addition to indicia representative of the geographic location of the real property and the transfer price at 502, 504.

Having thus described the system 100 and the method 200 in general terms, a specific illustration of the operation of the system 100 and method 200 is now discussed, again with reference to FIGS. 1-8. This illustration involves the use of the real property database 140 with its plurality of entries, each entry representing a real property. As illustrated in the tabular representation of the database 140 in FIGS. 3, 7 and 8, this database includes at least one hundred different properties arranged along one street. It will be recognized that according to the present disclosure, because the database 140 included in other embodiments may include millions of properties in thousands of municipal organizations around the world, the illustrated database 140 is has been limited primarily to simplify the discussion of the illustration.

As initially generated, the database 140 according to this illustration included information in the real property identifier field 302, the geographic location field 304, the exterior image field 308 and the real property listing image field 310. For example, such a database 140 may be established as part of the Google Maps service, wherein each individual real property may be provided with a unique real property identifier and associated with a particularized geographic description, and then an exterior image may be associated with the real property identifier as part of the Google Streetview service. Moreover, a real property listing image 500 may be generated by assembling a webpage from the foregoing information in fields 302, 304, 308, and this image 500 may also be associated with the entry 300 using the field 310.

According to this particular illustration, the communication and editing system 110 in communication with the database 140 and one of remote computers 120 may be programmed to carry out the above-mentioned method 200 relative to a right holder, for example the right holder (owner) of the real property located at 0 N Woodlawn (Real Property 1). The system 110 may begin (such as at block 204) by displaying at the remote computer 120 information relating to an unclaimed entry 300 representing Real Property 1 by displaying on the remote computer 120 the image 400 illustrated in FIG. 4. This image 400 may be displayed in the course of events of providing a separate service, such as the Google Maps service, or the image 400 may be displayed in response to a request received from the right holder.

Upon viewing the information, as represented by the image 400, the owner of Real Property 1 may select the entry (block 206). This process may also be referred to as claiming the entry 300. To do so, the owner of Real Property 1 may activate the link 416, which causes the system 110 to receive from the remote computer 120 a selection of the entry 300 for Real Property 1 (block 208).

As mentioned above, once a selection is received by the system 110, the system 110 may be programmed to confirm that the selection originated with the right holder (in this case, the owner) of Real Property 1 before providing the owner with the ability to edit the fields associated with the entry representing Real Property 1 (block 208). For example, the system 110 may use the afore-mentioned SMS method to exchange a token with the owner, which token the owner may use to confirm his or her identity to the system 110. Of course, other methods may be used to ensure the identity of the owner. Once confirmation has been received, the system 110 may provide the owner with the ability to edit the one or more additional fields 306, 310, 314, 316, 318, 320, 322, 324, 326, 328 associated with the entry 300 for Real Property 1 (block 210).

For example, the owner may begin by sending an edit command to modify the transfer price field 306 in FIG. 3 (block 212). As illustrated, the owner has caused the transfer price field 306 to be modified from a null field (no information associated, or zero value associated) such that it now contains information that the owner is willing to sell Real Property 1 for $200,000. The user interface used to produce the edit command received by the system 110 to cause this modification to be made to the database 140 may vary according to the implementation of the system 100 and method 200, and with respect to the computer 120 as well. However, whatever the interface used, the system 110 receives the edit command and modifies the database 140 to store information that can be used by the system 110 to communicate to others that the owner is willing to accept $200,000 for Real Property 1 (block 216).

Proceeding on with the method 200, the owner may provide further edit commands to complete other fields associated with the entry 300 associated with Real Property 1 (again, block 212). For example, the owner may have one or more interior images of the building associated with Real Property 1 that the owner would like to have associated with the entry 300 for Real Property 1. As a consequence, the system 100 may receive an edit command to modify the interior image field 312, which edit command involves uploading one or more interior images from the computer 120 to the system 110, and potentially the database 140, and associating those uploaded images with the interior image field 312 of the entry 300 for the Real Property 1.

In fact, as illustrated in FIGS. 7 and 8, the owner of Real Property 1 may provide additional edit commands to cause information to be included or stored in each of the fields 314, 316, 318, 320, 322, 324, 326. For example, the owner may provide and the system 110 may receive edit commands to include “Madison Township” with the governmental district field 314, “Superior Water” with the water district field 316, “District 456” as the primary education district in educational district field 318, and “Prairie Park District” with the recreational district field 320. In addition, the owner may provide and the system 110 may receive edit commands to include “3 Bedroom, 2 Bath” with the room field 322, “Central, Natural Gas” for central air conditioning and a natural gas furnace with the HVAC field 324, “City/City” for city water and city sewer in the water/sewer field 326, and “None” in the fixture field 328.

While the owner of Real Property 1 chose to cause each of the fields associated with the entry 300 for Real Property 1 to be modified, this is not a requirement of the present disclosure. For example, the right holder for Real Property 4 (located at 20 N Woodlawn) selected the entry associated with Real Property 4, but did not elect to upload and associated images with the interior image field 312. As such, the system 100 and method 200 according to the present disclosure permit considerable flexibility to the actual information stored in the database 140, while providing an organized and standardized set of possible types of information to be stored, when desired.

According to the illustration, the information stored in the database 140 by the owner of Real Property 1 may be displayed in a variety of fashions through the images in FIGS. 5 and 6 (block 214). For example, as noted previously, the original image 400 that was used by the system 110 to convey the information to the right holder to claim the entry 300 and its associated fields and real property listing image 500 may also be used to display information included in the database 140. As illustrated in FIG. 5, information from the transfer price field 306 may be displayed as indicia in image 400 that conveys to the viewer that the right holder for the real property at the location 412 on the map image 402 would be willing to accept $200,000 to transfer ownership of the real property.

In the alternative, one viewing the image 400 may use the link 410 to access the real property listing image 500, illustrated in FIG. 6. Again, the information included in the database 140 may be displayed as part of the image 500. In particular, the image 500 includes information from all of the fields 304-324 previously mentioned. Thus, one viewing the image 500 may determine the geographic location of the real property at 502 and the transfer price at 504. The party viewing the image 500 may also be able to view images at 506, 510 of the exterior and interior of the building located on the unit of land associated with the real property. Furthermore, indicia may be provided to communicate information about the governmental, water, educational, and recreational districts associated with the real property at 512, 514, 516, 518, respectively. Furthermore, indicia may be included in the image 500 relative to the building associated with the real property, such as the number and type of rooms (at 520), the air conditioning and furnace (at 522), the water and sewer connections (at 524), and the fixtures to be transferred with the building (at 526).

It will be recognized that modifications may be made at any time to the database 140 by the right holder once the right holder has selected the entry, thus claiming the real property listing. It will also be recognized that the modifications to the database 140 may be reflected in changes to the images 400, 500 simultaneously or contemporaneously with the modifications to the database 140. For example, if the owner wished to change the sale price for the real property, the owner could use the link 530 on the real property listing image 500 to access the communication and editing system 110, and to send an edit command to the system 110 to modify the information associated with the transfer price field 306 for the entry 300 associated with Real Property 1. For instance, the owner may decide to decrease the sale price from $200,000 to $180,000. The owner may consequently send an edit command to the system 110 to make this modification to the database 140 at the field 306. With the information at the field 306 thus updated, the indicia in the images 400, 500 at 418, 504 would be altered from “$200,000” to “$180,000” to reflect the change in sale price.

For that matter, while numerical indicia are displayed at 418, 504 in the images 400, 500, it is possible for the owner to use an edit command to change the information displayed at 418, 504 (by changing the information stored at transfer price field 306) to display alphanumeric or alphabetic characters. For example, if the owner receives a contract for to transfer the real property at the requested transfer price, “Under Contract” may be displayed at 418, 504 in response to a modification of the field 306. As a further alternative, the owner may modify the field 306, and thus the images 400, 500, to reflect the completion of the sale of the real property.

Other modifications will also be recognized, relative to the method and the system. For example, the networks 130 may include, by way of example but not by way of limitation, any combination of a LAN, MAN, WAN, mobile, wired or wireless network, a private network, or a virtual private network. While only three remote computer 120 are shown to simplify the disclosure, it will be recognized that very large numbers of computers 120 may be supported and in communication with the communication and editing system 110.

Both the communication and editing system 110 and the computers 120 may include a processor, a memory, a network interface, peripheral interfaces, and other well known components. As will be recognized, other types of computers can be used that have different architectures. The communication and editing system 110 and the computers 120 may also be adapted to execute computer program modules for providing functionality described herein. As used herein, the term “module” refers to computer program logic used to provide the specified functionality. Thus, a module can be implemented in hardware, firmware, and/or software. In one embodiment, program modules are stored in on a storage device, loaded into memory, and executed by a processor or can be provided from computer program products that are stored in tangible computer-readable storage mediums (e.g. RAM, hard disk, or optical/magnetic media).

Alternatively, many other configurations are possible. For example, the database 140 may be physically located within the communication and editing system 110. As further alternatives, the database 140 may be stored in external storage attached to communication and editing system 110, placed within one of the computers 120, or stored in network attached storage. Additionally, there may be multiple communication and editing systems 110 that connect to and are in communication with a single database 140.

Along similar lines, it will be recognized that although the preceding text sets forth a detailed description of different embodiments of the invention, it should be understood that the legal scope of the invention is defined by the words of the claims set forth at the end of this patent. The detailed description is to be construed as exemplary only and does not describe every possible embodiment of the invention since describing every possible embodiment would be impractical, if not impossible. Numerous alternative embodiments could be implemented, using either current technology or technology developed after the filing date of this patent, which would still fall within the scope of the claims defining the invention.

Further, to the extent that any term recited in the claims at the end of this patent is referred to in this patent in a manner consistent with a single meaning, that is done for sake of clarity only so as to not confuse the reader, and it is not intended that such claim term be limited, by implication or otherwise, to that single meaning. Finally, unless a claim element is defined by reciting the word “means” and a function without the recital of any structure, it is not intended that the scope of any claim element be interpreted based on the application of 35 U.S.C. §112, sixth paragraph. In addition, it should be understood that, unless a term is expressly defined in this patent using the sentence “As used herein, the term ‘______ ’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims).

In relation to this application, real property refers to property other than personal property. In this regard, real property may be understood as referring to immoveable property in those jurisdictions that make a distinction for purposes of property law between moveable and immovable property. Real property may also be used synonymously with real estate. However, to the extent that certain jurisdictions refer to real estate as the land and fixtures together, as distinguished from ownership of land and appurtenances, including anything of a permanent nature such as structures, trees, minerals, and the interest, benefits, and inherent rights thereof, the term real property refers to the broadest, most inclusive description.

By way of example and not by way of limitation, real property may include land along with improvements to the land, such as buildings, fences, wells and other site improvements that are fixed in location. Similarly, real property may include hereditary allowances, rights to way, or any benefit which arises out of land, and things attached to the earth or permanently fastened to anything which is attached to the earth. For ease of discussion and not by way of limitation, the illustrations of real property discussed herein focus on the land, buildings, and fixtures disposed in the buildings.

In regard to real property and the transfer of real property, the illustrations described herein refer to rights, which may include those interests referred to as estates in certain jurisdictions. As such, real property rights may include estates in real property, such as the fee simple and leasehold. These rights may be held by a single party, or jointly with other parties. To this extent, the right holder may have a share of the rights to a particular piece of real property, which may be divisible or indivisible. These examples of real property rights are provided to illustrate the breadth of the term as used herein, but not to limit the term only these exemplary illustrations.

1. A computer implemented method for use with a computerized database comprising a plurality of unclaimed entries, each unclaimed entry comprising at least a geographic location field containing information regarding a geographic location and one or more additional editable fields, the method comprising:
transmitting, using a computerized communication and editing system comprising a processor and memory, information relating to an unclaimed entry to a remote computer;
receiving, using the computerized communication and editing system, from the remote computer a selection of the unclaimed entry to claim the unclaimed entry;
confirming, using the computerized communication and editing system, that the selection from the remote computer originated with a right holder associated with the geographic location;
providing the right holder with the ability to edit the one or more additional editable fields associated with the claimed entry through the computerized communication and editing system after confirming, using the computerized communication and editing system, that the selection of the entry from the first remote computer originated with the right holder associated with the geographic location.
the ability to edit the one or more additional editable fields associated with the claimed entry including permission to add information to at least one of the one or more additional editable fields, but not to delete information already present;
subsequently modifying through the computerized communication and editing system a transfer price field in response to an edit command received from the right holder, the transfer price field containing information regarding a transfer price associated with the geographic location, the transfer price field being one of the at least one of the one of more additional editable fields, and
displaying an evolution of information added to the transfer price field over time.

2. The method according to claim 1, wherein the computerized database includes an exterior image field associated with an exterior image of a building associated with the geographic location with the exterior image field; and
subsequently displaying, using the computerized communication and editing system, a real property listing image including indicia representative of the geographic location, the transfer price and the exterior image of the building.

3. The method according to claim 2, comprising subsequently displaying, using the computerized communication and editing system, a map image including the geographic location, the map image including a link to the real property listing image at a location on the map image associated with the geographic location.

4. The method according to claim 3, comprising displaying, using the computerized communication and editing system, a listing icon at the location on the map image associated with the geographic location to highlight the link to the real property listing image.

5. The method according to claim 1, comprising:
subsequently modifying, using the computerized communication and editing system, an interior image field in response to an edit command received from the right holder to associate one or more interior images of a building associated with the geographic location with the interior image field; and
displaying, using the computerized communication and editing system, a real property listing image including indicia representative of the geographic location, the transfer price and the one or more interior images of the building.

6. The method according to claim 1, comprising:
subsequently modifying, using the computerized communication and editing system, the one or more additional fields in response to an edit command received from the right holder to include information representative of one or more of a governmental district, a water district, an educational district, and a recreational district; and
displaying, using the computerized communication and editing system, a real property listing image including indicia representative of the geographic location, the transfer price and one or more of the governmental district, the water district, the educational district, and the recreational district.

7. The method according to claim 1, comprising:
subsequently modifying, using the computerized communication and editing system, the one or more additional fields in response to an edit command received from the right holder to include information representative of one or more of a room description, a HVAC description, a water/sewer description, and a fixture description; and
displaying, using the computerized communication and editing system, a real property listing image including indicia representative of the geographic location, the transfer price and the one or more of the room description, the HVAC description, the water/sewer description, and the fixture description.

8. A computerized system comprising:
a real property database comprising a plurality of unclaimed entries, each unclaimed entry representing a geographic location and comprising at least a geographic location field containing information regarding a geographic location and one or more additional editable fields; and
a computerized communication and editing system in communication with the database and a remote computer, the communication and editing system comprising a processor and memory and programmed to:
transmit information relating to an unclaimed entry to the remote computer;
receive from the remote computer a selection of the unclaimed entry to claim the unclaimed entry;
confirm that the selection from the remote computer originated with a right holder associated with the geographic location;
provide the right holder with the ability to edit the one or more additional editable fields associated with the claimed entry after confirming that the selection of the entry from the first remote computer originated with the right holder associated with the geographic location,
the ability to edit the one or more additional editable fields associated with the claimed entry including permission to add information to at least one of the one or more additional editable fields, but not to delete information already present;
subsequently modify a transfer price field in response to an edit command received from the right holder, the transfer price field containing information regarding a transfer price associated with the geographic location, the transfer price field being one of the at least one of the one of more additional editable fields, and
display an evolution of information added to the transfer price field over time.

9. The system according to claim 8, wherein the real property database includes an exterior image field associated with an exterior image of a building associated with the geographic location with the exterior image field; and the communication and editing system is programmed to subsequently display a real property listing image including indicia representative of the geographic location, the transfer price and the exterior image of the building.

10. The system according to claim 9, wherein the communication and editing system is programmed to subsequently display a map image including the geographic location, the map image including a link to the real property listing image at a location on the map image associated with the geographic location.

11. The system according to claim 10, the communication and editing system is programmed to display a listing icon at the location on the map image associated with the geographic location to highlight the link to the real property listing image.

12. The system according to claim 8, the communication and editing system is programmed to:
subsequently modify an interior image field in response to an edit command received from the right holder to associate one or more interior images of a building associated with the geographic location with the interior image field; and
display a real property listing image including indicia representative of the geographic location, the transfer price and the one or more interior images of the building.

13. The system according to claim 8, the communication and editing system is programmed to:
subsequently modify the one or more additional fields in response to an edit command received from the right holder to include information representative of one or more of a governmental district, a water district, an educational district, and a recreational district; and
display a real property listing image including indicia representative of the geographic location, the transfer price and one or more of the governmental district, the water district, the educational district, and the recreational district.

14. The system according to claim 8, the communication and editing system is programmed to:
subsequently modify the one or more additional fields in response to an edit command received from the right holder to include information representative of one or more of a room description, a HVAC description, a water/sewer description, and a fixture description; and
display a real property listing image including indicia representative of the geographic location, the transfer price and the one or more of the room description, the HVAC description, the water/sewer description, and the fixture description.

15. A computerized system comprising:
a real property database comprising a plurality of unclaimed entries, each unclaimed entry representing a geographic location and comprising at least a geographic location field containing information regarding a geographic location and one or more additional editable fields; and
a computerized communication and editing system in communication with the database and a remote computer, the communication and editing system comprising a processor and memory and programmed to:
receive from the remote computer a selection of the unclaimed entry to claim the unclaimed entry;
confirm that the selection from the remote computer originated with the right holder associated with the geographic location;
modify a transfer price field in response to an edit command received from a right holder, the transfer price field containing information regarding a transfer price associated with the geographic location after confirming that the selection of the entry from the first remote computer originated with the right holder associated with the geographic location, the transfer price field being one of the one or more additional editable fields for which information may be added, but information already present may not be deleted; and
subsequently transmit a real property listing image including indicia representative of the geographic location and an evolution of information added to the transfer price field over time.

16. The system according to claim 15, wherein the real property database includes an exterior image field associated with an exterior image of a building associated with the geographic location with the exterior image field; and
the communication and editing system is programmed to subsequently display a real property listing image including indicia representative of the geographic location, the transfer price and the exterior image of the building.

17. The system according to claim 16, wherein the communication and editing system is programmed to subsequently display a map image including the geographic location, the map image including a link to the real property listing image at a location on the map image associated with the geographic location.

18. The system according to claim 17, the communication and editing system is programmed to display a listing icon at the location on the map image associated with the geographic location to highlight the link to the real property listing image.

19. The system according to claim 15, the communication and editing system is programmed to:
subsequently modify an interior image field in response to an edit command received from the right holder to associate one or more interior images of a building associated with the geographic location with the interior image field; and
display a real property listing image including indicia representative of the geographic location, the transfer price and the one or more interior images of the building.

20. The system according to claim 15, the communication and editing system is programmed to:
subsequently modify the one or more additional fields in response to an edit command received from the right holder to include information representative of one or more of a governmental district, a water district, an educational district, a recreational district, a room description, a HVAC description, a water/sewer description, and a fixture description; and
display a real property listing image including indicia representative of the geographic location, the transfer price and one or more of the governmental district, the water district, the educational district, the recreational district, the room description, the HVAC description, the water/sewer description, and the fixture description. /

21. A computer implemented method for use with a computerized database comprising a plurality of unclaimed entries, each unclaimed entry comprising at least a geographic location field containing information regarding a geographic location and one or more additional editable fields, the method comprising:
collecting information regarding an unclaimed entry;
storing, using a computerized communication and editing system comprising a processor and memory, the information in one or more of the additional editable fields;
subsequently receiving, using the computerized communication and editing system, from a remote computer a selection of the unclaimed entry to claim the unclaimed entry;
confirming, using the computerized communication and editing system, that the selection from the remote computer originated with a right holder associated with the geographic location;
subsequently modifying through the computerized communication and editing system a transfer price field in response to an edit command received from the right holder, the transfer price field containing information regarding a transfer price associated with the geographic location, the transfer price field being one of the one or more additional editable fields for which information may be added, but information already present may not be deleted; and
transmitting, using the computerized communication and editing system, a real property listing image including indicia representative of the geographic location and an evolution of information added to the transfer price field over time.

22. The method according to claim 21, comprising:
storing, using the computerized communication and editing system, an exterior image of a building associated with the geographic location in an exterior image field; and
subsequently displaying, using the computerized communication and editing system, a real property listing image including indicia representative of the geographic location, the transfer price and the exterior image of the building.

23. The method according to claim 22, comprising subsequently displaying, using the computerized communication and editing system, a map image including the geographic location, the map image including a link to the real property listing image at a location on the map image associated with the geographic location.

24. The method according to claim 23, comprising displaying, using the computerized communication and editing system, a listing icon at the location on the map image associated with the geographic location to highlight the link to the real property listing image.

25. The method according to claim 21, comprising:
storing, using the computerized communication and editing system, one or more interior images of a building associated with the geographic location with an interior image field; and
displaying, using the computerized communication and editing system, a real property listing image including indicia representative of the geographic location, the transfer price and the one or more interior images of the building.

26. The method according to claim 21, comprising:
storing, using the computerized communication and editing system, information representative of one or more of a governmental district, a water district, an educational district, and a recreational district; and
displaying, using the computerized communication and editing system, a real property listing image including indicia representative of the geographic location, the transfer price and one or more of the governmental district, the water district, the educational district, and the recreational district.

27. The method according to claim 21, comprising:
storing, using the computerized communication and editing system, information representative of one or more of a room description, a HVAC description, a water/sewer description, and a fixture description; and
displaying, using the computerized communication and editing system, a real property listing image including indicia representative of the geographic location, the transfer price and the one or more of the room description, the HVAC description, the water/sewer description, and the fixture description.
